(19) United States
(12) Patent Application Publication
(10) Pub. No.: US 2007/0124264 A1
(43) Pub. Date: May 31, 2007

(54) Deconvolution and segmentation based on a network of dynamical units

(75) Inventors: Guillermo A. Cecchi, New York City, NY (US); James R. Kozloski, New Fairfield, CT (US); Charles C. Peck, Newton, CT (US); Ravishankar Rao, Elmsford, NY (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/282,898

(22) Filed: Nov. 18, 2005

(51) Int. Cl. G06N 3/02

(52) U.S. Cl. 706/15

(57) ABSTRACT

A system and method for a network to deconvolve mixtures of inputs that have been previously learned. In addition, the network is also able to segment the components of each input object that most contribute to its classification. The network consists of oscillatory units that can comprise amplitude and phase, and that can synchronize their dynamics, so that deconvolution is determined by the amplitude of an output layer, and segmentation by phase similarity between input and output layer units. Moreover, segmentation can be achieved even when there is considerable superposition of the inputs.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to field of signal processing, and separation of source signals from a mixture of signals and more specifically to the fields of signal deconvolution.

### BACKGROUND OF THE INVENTION

An important problem described in the signal processing and neural information processing literature is that of the so-called cocktail party problem, where one would like to identify individual voices when they are mixed together. See Ch. Von der Malsburg and W. Schneider, “A Neural Cocktail Party Processor,” Biol. Cybern., 54(1):29-40 (1986). This problem has been tackled by methods such as independent component analysis (ICA). See A. J. Bell and T. J. Sejnowski, “An information-maximization approach to blind separation and blind deconvolution,” Neural Computation, 7:1129-1159 (1995).

Though techniques such as ICA can perform the separation of the signal sources, they cannot directly identify which signal source is dominant at any particular instant in time. The reason is that they are global techniques, and make use of the probability distributions of the different signal sources, which requires the extraction of global statistics. It is difficult for these techniques to provide precise local information such as which signal is dominant at an instant in time.

We refer to this ability to provide local information as the ability to segment the input signal. Hence, a technique is desired which can provide signal separation or identification combined with segmentation of learning, the network is able to recognize previous inputs that it has been shown.

Deconvolution and blind deconvolution (i.e. identifying the presence of specific objects in the visual field) have been extensively studied in the neural network literature. A. J. Bell and T. J. Sejnowski, supra. On the other hand, segmentation, which refers to the ability to identify the elements of the input space that uniquely contribute to each specific object (i.e. establishing a correspondence between the pixels or edges and the higher-level objects they belong to), has been attacked more effectively with non-neural approaches. S. Ullman, M. Vidal-Naquet, E. Sali E., “Visual features of intermediate complexity and their use in classification,” Nature Neuroscience 5(7):682-7 (2002).

However, inspired by experimental evidence of a role for synchronization of neural responses in a variety of motor and cognitive tasks, and in particular in perceptual recognition, Malsburg and Shneider were among the first to propose the use of synchronization to perform segmentation of a mixture of signals. C. M Gray, P. Koenig, A. K. Engel and W. Singer, “Oscillatory responses in cat visual cortex exhibit inter-columnar synchronization which reflects global stimulus properties,” Nature, 338(6213):334-337 (1989); E. Rodriguez, N. George, J. P. Lachaux, J. Martinerie, B. Renault and F. J. Varela, “Perception's shadow: long-distance synchronization of human brain activity. Nature,” 397(6718):430-433 (1999); Ch. von der Malsburg and W. Schneider, “A neural cocktail-party processor,” Biol. Cybern., 54(1):29-40 (1986). Their model consists of a layer of excitatory units connected with lateral excitation. Each of these excitatory units receives sensory input. Furthermore, every excitatory unit is connected to a global inhibitory unit which receives excitatory inputs, and sends inhibitory signals to each of the excitatory units. Segmentation is exhibited in the form of temporal correlation amongst the activities of the different excitatory units, so that the units that are synchronized represent the same input class. Besides the need for a global inhibitory unit, this network cannot disambiguate objects with partial overlap. Ch. von der Malsburg and W. Schneider, supra. Indeed, a number of approaches derived from inherit the same shortcomings, and therefore the issue of effective segmentation by networks of synchronizing units needs to be addressed. J. Buhmann and C. Von Der Malsburg, “Sensory segmentation by neural oscillators,” International Joint Conference on Neural Networks, Part II, pp. 603-607 (1991), K. Chen and D. Wang and X. Liu, “Weight Adaptation and Oscillatory Correlation for Image Segmentation,” IEEE Transactions on Neural Networks, 11(5):1106-1123 (2000), D. L. Wang and X. Liu, “Scene analysis by integrating primitive segmentation and associative memory,” IEEE Transactions on Systems, Man, and Cybernetics, Part B, 32(3):254-268 (2002).

The original network proposed by Malsburg and Shneider has been influential in advancing a theory for the use of synchrony as a solution to segmentation. J. Buhmann and C. Von Der Malsburg, “Sensory segmentation by neural oscillators,” International Joint Conference on Neural Networks, Part II, pp. 603-607 (1991). However, the specific implementation proposed in their paper has several shortcomings. Firstly, a global inhibitory neuron is required. Secondly, learning in their model requires a combination of short-term and long-term synaptic modification. Thirdly, the test cases used in their model did not involve any overlap amongst the spectral inputs to be separated. Buhman and Malsburg explicitly introduced oscillatory units into the model, but their model suffers from earlier noted shortcoming in that the presence of a global inhibitory unit is required. Buhmann and C. Von Der Malsburg, Sensory segmentation by neural oscillators. International Joint Conference on Neural Networks, Part II, pp. 603-607(1991). The subsequent work of Chen, Wang and Liu, and Wang and Liu offer enhancements of the original model, but maintains the essential aspect of utilizing a global inhibitor. K. Chen and D. Wang and X. Liu, “Weight Adaptation and Oscillatory Correlation for Image Segmentation,” IEEE Transactions on Neural Networks, 11(5):1106-1123(2000). The work of Izhikevich is mainly theoretical, and does not present any specific methodology to address the problem of segmentation. E. M. Izhikevich, “Weakly Pulse-Coupled Oscillators, FM Interactions,” Synchronization, and Oscillatory Associative Memory. IEEE Transactions on Neural Networks, 10(3):508-526 (1999). Hoppensteadt and Izhikevich illustrate their method with a single example using three inputs, and have not applied their methodology to a larger number of inputs or test cases, or addressed the segmentation problem. F. C. Hoppensteadt and E. M. Izhikevich, “Pattern Recognition Via Synchronization in Phase-Locked Loop Neural Networks,” IEEE Transactions on Neural Networks, 11(3):734 (1999). Furthermore, they raise the issue that the Hebbian learning rule they use may not be the best. The method of Sun et al requires the use of visual motion to perform segmentation, and hence is not applicable to static inputs as we have investigated. Furthermore, their scheme relies on supervised training, and uses back-propagation learning. H. Sun, L. Liu and A. Guo, “A Neurocomputational Model of Figure-Ground Discrimination and Target Tracking,” IEEE Transactions on Neural Networks, 10(4):860-884(1999).

U.S. Pat. Nos. 6,236,862 B1 and 6,625,587 B1 disclose a method and apparatus for dynamically separating signal sources from a received mixture. Their method however, does not address and solve the problem of segmentation as described in the current invention, and the establishment of a correspondence between local input features and individual signal sources.

### SUMMARY OF THE INVENTION

In an embodiment of the invention, a network architecture can efficiently segment overlapping one-dimensional inputs, and can be generalized to higher dimensions. The network used in this embodiment comprises oscillatory units that each possesses an amplitude of oscillation, a frequency, and phase. Out of these properties, the amplitude and phase are the most critical for the network to exhibit the desired behavior of segmentation and deconvolution. These units are organized into multiple layers, and each unit receives feedforward, feedback, and lateral connections from other units. Furthermore, each unit is connected to other units. The different classes of connections (feedforward, feedback and lateral) affect the receiving unit in different ways. Each connection is represented by a weight, which is learnt or modified according to learning rules. Through this process of learning, the network is able to recognize previous inputs that it has been shown. This learning proceeds in a self-organized manner, i.e. the process is unsupervised.

This network is also able to deconvolve mixtures of inputs that have been previously learned. In addition, the network can segment the components of each input object that most contribute to its classification. This is achieved by the ability of the units in the network can synchronize their dynamics, so that deconvolution is determined by the amplitude of an output layer, and segmentation by phase similarity between input and output layer units. Learning is unsupervised and based on a Hebbian update, and the architecture is very simple. Moreover, efficient segmentation can be achieved even when there is considerable superposition of the inputs.

One embodiment overcomes the global inhibitory restriction and spreads inhibition across the entire network, which is more biologically plausible. In our model the learning is reduced to a single generic rule. The long term and short term synaptic modification, which in some embodiments is reduced to a single generic rule. Embodiments allow complete overlap, and shows that successful separation and segmentation is still possible. Other embodiments use the Hebbian rule, which is simple, and we have shown that it works extremely well.

### BRIEF DESCRIPTION OF THE DRAWINGS

FIGS. 1A-C are a high level block diagrams showing a two-layer representation of a network according to an embodiment of the invention.

FIG. 2A is an instance of the input of an input ensemble.

FIG. 2B illustrates the behavior of the network after training.

FIG. 3A illustrates the two inputs used.

FIG. 3B is a mixture of the two inputs presented to the system.

FIG. 3C is the winner for input 1, W1 is the winner for input 1 and W2 is the winner for input 2.

FIG. 4A is the conditional probability distribution for deconvolution figures.

FIG. 4B shows average segmentation accuracy versus the dot product of the inputs selected for mixing.

FIG. 5A is the average deconvolution accuracy versus the noise level.

FIG. 5B is an average classification accuracy versus the noise level.

### DETAILED DESCRIPTION

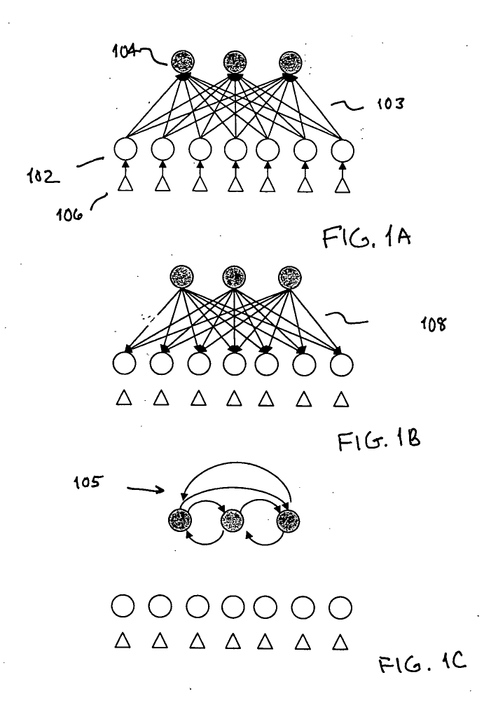

Referring to FIG. 1A, there is shown a block diagram of a learning (neural) network 100 according to an embodiment of the invention. The network 100 comprises a plurality of units (e.g., neurons) in an input (bottom) layer 102, a second plurality 104 of units in an output (upper) layer, and a feedforward connection 103 to each of the second plurality of units 104. FIG. 1B, shows the feedback 108 connection from the output layer 104 to the input layer 102. FIG. 1C shows the lateral connections 105 within the output layer 104.

The network 100 performs dynamical segmentation based on the idea that each of the network's units can be described in terms of an amplitude and a phase, and that the feedforward and feedback connections (excitatory or inhibitory) can affect the receiving unit's amplitude and phase in qualitatively different ways.

The input (bottom) layer 102 receives an input from an input signal 106. The network 100 comprises dynamical units. The amplitude output of these units is only a function of their inputs, whereas the phase is a function of the their internal frequency, and feedback interactions with an output layer 104. An output layer 104 consists of dynamical units that receive an input from the input layer 102 through feedforward connections 108. For these units, the amplitude and the phase are computed by integrating inputs as a function of their amplitude and their phase difference with respect to the receiving phase. The output layer 104 sends feedback to the input layer 102, which is used to modify only the phase of the bottom layer's units as a receiving phases.

The input space consists of an ensemble of vectors {xₙ}, n=1, . . . , M, such that xₙ ε [0,1]^{N}, |xₙ|=1∀n. The bottom layer 102 consists of N oscillators with amplitude r₁≧0, phase θ₁ ε [0, 2π], and frequency ω₁ ε [ω₁^{m}, ω₁^{M}]; similarly the top layer consists of N oscillators described by amplitude r₂, phase θ₂ and frequency ω₂ ε [ω₂^{m},ω₂^{M}]. The bottom layer feeds forward into the top one with connection , where i ranges over top units and j over bottom ones. Similarly, the top layer feeds back into the bottom one, with connections Wᵢ^{F}ⱼ where i ranges over the bottom units, and j over the top ones. The top layer has inhibitory connections onto itself, Gij . Feed-forward and feedback connections are normalized, such that
Wᵢ^{l} ε [0, 1]^{N}, ∥Wᵢ^{j}∥=1, where Wᵢ={Wᵢ₁, . . . , W_{iN}}
and f={F, B, I}.

The network operates in two stages, learning and performance. Only during the learning stage are the feedforward and feedback connections modified, whereas the inhibitory connections are fixed throughout. During the learning stage, elements of the input ensemble are presented to the network, upon which the response of the network is dynamically computed. A unit's phase update is the result of its internal frequency, and of integrating all feedforward, inhibitory and feedback inputs, weighted by their amplitude and the receiving unit's amplitude, as well as by a non-linear function of their relative phases with respect to the receiving unit. For the amplitude update, the incoming amplitudes are weighted by a non-linear function of the relative phases, and limited by a leakage function of the receiving unit's amplitude. Qualitatively, the effect of one input unit j, where j ε[1 . . . N] on a receiving unit i can be written as Δrᵢ∝−μrᵢ+rjH(θᵢ−θⱼ) and Δθᵢ∝ωᵢ+rⱼQ(θᵢ−θⱼ), where the functions Q and H depend on the nature of the input, i.e. feedforward, feedback or inhibitory. The rationale for these equations is the following: (a) the effect of feedforward inputs on the amplitude is stronger for synchronized units; (b) excitatory feedforward and feedback connections are such that units that are simultaneously active tend towards phase synchrony; and (c) inhibitory connections tend towards de-synchronization; at the same time, they have a stronger depressing effect on the amplitude of synchronized units, and correspondingly a weaker effect for de-synchronized units.

Formally, the update equations for the units in the input and output layers are:
\dot{θ}₁_{ᵢ}=ω₁_{ᵢ}+ΣⱼWᵢ^{B}ⱼρ₂_{ⱼ}τ₁_{ᵢ}Φ_{B}(θ₁_{ᵢ}−θ₂_{ⱼ}) (1)
\dot{τ}₂_{ᵢ}=−μτ₂_{ᵢ}+ΣⱼWᵢ^{F}ⱼτ₁_{ⱼ}Γ_{Fr}(θ₂_{ᵢ}−θ₁_{ⱼ})−γ_{τ}ΣₖGᵢₖρ₂_{ₖ}Γ₁_{ᵣ}(θ₂_{ᵢ}−θ₂_{ₖ}) (2)
\dot{θ}₂_{ᵢ}=ω₂_{ᵢ}+ΣⱼWᵢ^{F}ⱼτ₁_{ⱼ}Φ_{F}_{_{θ}}(θ₂_{ᵢ}−θ₁_{ⱼ})−γ_{θ}ΣₖGᵢₖτ₂_{ₖ}Φ_{I}_{θ}(θ₂_{ᵢ}−θ₂_{ₖ}) (3)
Φ_{F}_{_{θ}}(φ)=sin(φ)Γ_{F}_{_{θ}}(φ), Φ_{B}_{_{θ}}(φ)=sin(φ)Γ_{Bθ}(φ), Φ_{I}_{_{θ}}(φ)=−sin(φ)Γ_{I}_{_{θ}}(φ), Γ_{α}=e^{-(1-cos(φ))} ^{/2σ}^{_{α}} where α={F_{τ}, I_{τ}, F_{θ}, I_{θ}}; the initial conditions for the presentation of an input (t=0 is input onset) are:
θ₁_{ᵢ}(t=0)=0∀i, θ₂_{ᵢ}(t=0)=0∀i, τ₁ᵢ(t)=χᵢ⁽ⁿ⁾∀t≧0 τ₁ᵢ(t)=χᵢ⁽ⁿ⁾∀t≧0
Finally, the upper layer's amplitude is rectified, such that \dot{τ}ᵢ≧0∀i if τᵢ=0.

During the learning stage, feed-forward, feedback and inhibitory connections are subject to plastic changes. These changes are a generalization of the simple Hebbian rule of synaptic update, based on the coincidence of activity between the pre-synaptic and post-synaptic units, i.e. the incoming and receiving units defined by a connection. The rules are written as follows:
\dot{W}ᵢ^{f}ⱼ=β_{f}τᵢτⱼΓ_{f}(θⱼ−θᵢ)
where f={F, B, I}. This implies that learning for the three classes of connections has the same functional form, and consequently the strength of inhibitory connections will increase if both units tend to be coactive. During the performance stage, the response equations are identical, the only difference being that learning is turned off. Further changes may be implemented either gradually over the course of learning, or discretely at the transition between the learning and performance stages. For the results presented in the next section, learning constants were decreased to approach zero with an exponential schedule.

Thus, during the learning phase, the learning network 100 creates a weight for each connection between the units. The weight of a connection can be changed according to a product of the amplitudes of the units connected. For example if the inputs A and B are received at the input layer, then the weight can be changed as the product of their amplitudes. In addition, the network 100 can also update in proportion to the phase difference between the two units connected.

In the operational phase, for example a signal is received that has two objects (e.g., images). The network 100 produces an output that can recognize that the input contains an image (e.g., a face). The network 100 can also recognize the presence of a mixture of images (e.g., a face and a car). The network 100 was trained with pictures of faces and pictures of cars. The network 100 can also segment which pictures came form the face and which came form the car.

Dynamical Segmentation.

FIG. 2A shows an instance of the input ensemble used to test the segmentation algorithm. FIG. 2B shows the behavior of the network after learning. The traces (a) and (c) show the amplitude and phase response upon presentation of an input from the training ensemble. In traces (b) and (d) we see the response to the presentation of a mixture. For the amplitude, the evolution is shown since input onset; for the phase, only the behavior after convergence is shown. Empty circles correspond to the traces from the input layer and circles with a dot inside represent the units from the input layer.

The algorithm was run on training inputs drawn uniformly for ten-dimensional vectors. Time is in simulation steps. The units compete to represent the input, until one wins and shuts down the others. This leads to a global synchronization at small phase difference of all lower layer units with the winner, which emerges after 3-4 cycles as determined by the mean frequency of the oscillators. The existence and stability of 1:1 synchronized states is predicated upon a relatively small spread of natural differences. In contrast, when a mixture of training examples is presented there is also synchronization (emerging in a similar time scale), but competition leads to the emergence of two winners, which divide up the lower layer in terms of phase difference.

Our initial results show that indeed the system is able to separate or deconvolve a mixture of two components, drawn at random from the training ensemble, into its original values. In short, we found that over 1,000 different realizations of the input ensemble, 75% of the cases we correctly deconvolve. The other 25% consisted of wrong winners emerging, including 1% of cases when at least one of the components was correctly identified. More importantly for the goal of the this paper, of the 75% correctly deconvolved cases, there was 93.6% accuracy for segmentation.

For the deconvolution, the identity of the input is based on the elements of the upper layer whose amplitude exceeds a threshold, rᵢ≧0.1. After learning, presentation of a pure exemplar always leads to a single winner. On the other hand, the segmentation is computed by assigning to each winner in the upper layer the units in the lower layer whose phase is closest, after settling. More precisely, let unit i in the upper layer be the winner for an input x₁, and let unit j be the winner for input x₂. Suppose units i and j in the upper layer are the winners for a presentation consisting of a mixture of two inputs, x₁ and x₂, indicating that deconvolution has taken place correctly. Let the phases of units i and j in the upper layer be θ₂ᵢ and θ₂ⱼ respectively. Consider a unit k in the lower layer with phase θ₁ₖ. The behavior of the network is such that the phase of the k^{th} unit is usually synchronized with the phase of one of the winners in the upper layer. Suppose, without loss of generality, that θ₁ₖ˜θ₂ᵢ, i.e. the phase of unit k in the lower is close to the phase of unit i in the upper layer. We observe another interesting behavior in the network, in that x₁ₖ>x₂ₖ, i.e. the input at location k is higher for the first input. In other words, the network is able to implicitly determine which input is higher at a given position, forming the basis of segmentation. We say that the input at location k is correctly segmented if the following holds true: let the higher of the two inputs at location k be x₁, and let the winner at the upper layer that responds to input x₁ be i. If the phase of the input unit at k, θ₁ₖ˜θ₂ᵢ, then input at location k is correctly segmented. The overall segmentation accuracy for a given pair of inputs is determined by counting the number of units in the lower layer that are correctly synchronized with the appropriate winners in the upper layer.

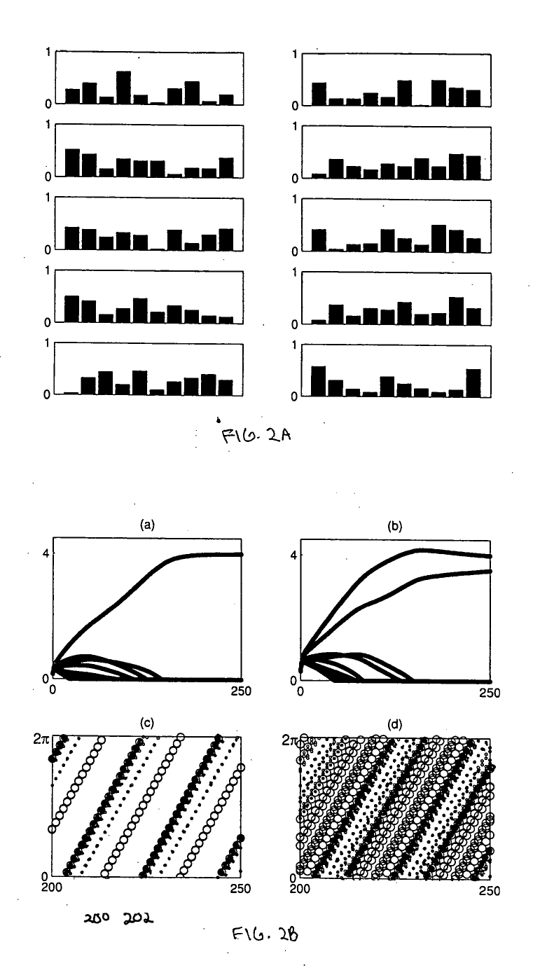

FIGS. 3A-C show a concrete example to illustrate segmentation. FIG. 3A shows two inputs used. FIG. 3B show mixture of the two inputs is presented to the system. FIG. 3C shows the winner for input 1, W1, and the winner for input 2, W2. The system's phase response to a mixture of signals is shown in FIG. 3C, where it can be seen that the segregation of phases and the implicit rule that if x₁ⱼ>x₂ⱼ then the input element at location j follows the phase of the winner for input 1. Thus, the phase at each input unit shows which input is higher at that particular point.

We investigated the relationship between the determinant of the input matrix and the error rate for deconvolution. Let d be the determinant of the input matrix. This was converted to a normalized form that D is equal to the tenth root of d, as the dimensionality of the input matrix was 10, and the input vectors are normalized to unity.

FIG. 4A is a conditional probability distribution for deconvolution failures and summarizes the results of over 500 trials. FIG. 4B shows the average segmentation accuracy versus the dot product of the inputs selected for mixing.

We compute the conditional probability for deconvolution failure p(F\D) as a function of D (the unconditional distribution of D is approximately Gaussian—not shown). Ignoring the noise at the tail ends of the distribution, we see that the failure to deconvolve is not dependent on the determinant of the input matrix, indicating that the method is quite robust. If there was a dependence, we would have expected that the failure to deconvolve would increase as D decreased. However, this does not appear to be the case.

We further characterized segmentation by measuring the relationship between the dot product of the inputs selected for mixing, and the segmentation accuracy after deconvolution. One expects that as the inputs become more similar, i.e. as their dot product increases, the segmentation task becomes more difficult, and the segmentation accuracy will decline. A total of 351 cases were analyzed to produce this result. As the value of the dot product increases, the segmentation accuracy decreases from 100% to about 80%.

Average classification accuracy versus the noise level a normalized form, as the dimensionality of the input matrix was 10, and the input vectors are normalized to unity.

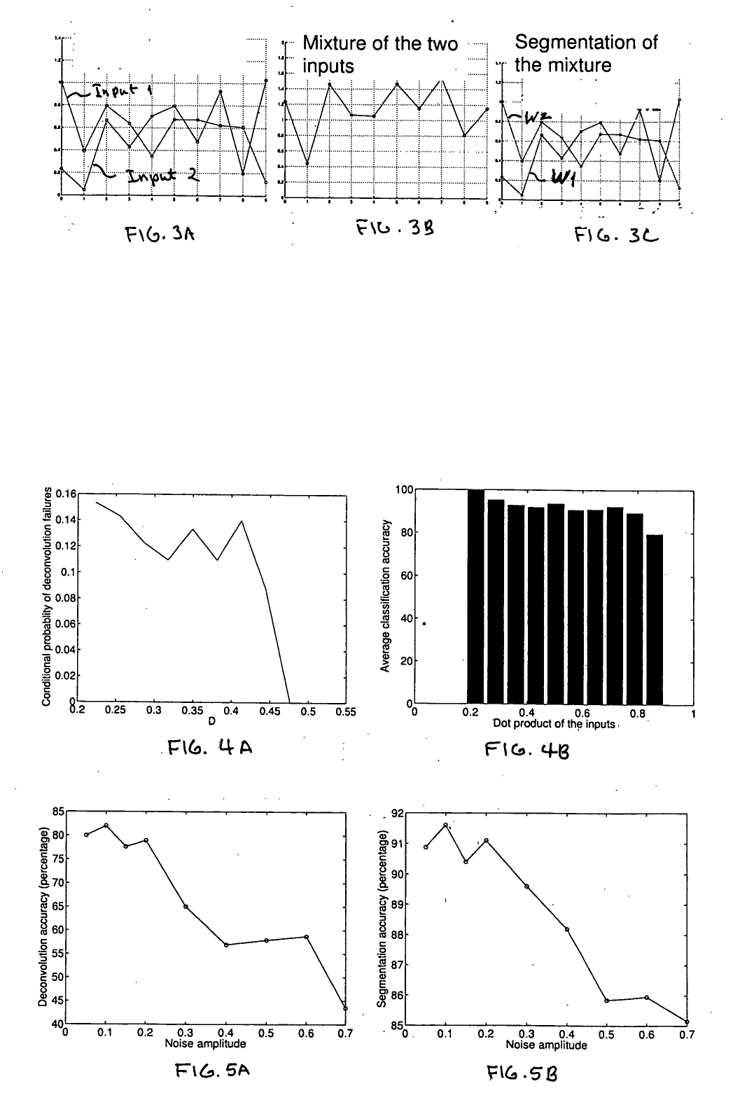

FIGS. 5A-5B show the effect of adding noise on the deconvolution and classification performance. FIG. 5A shows the average deconvolution accuracy versus the noise level. FIG. 5B shows the average classification accuracy versus the noise level. We added uniform noise up to a maximum noise level, η, where η was varied between 0.05 and 0.7. Thus the input was perturbed by noise drawn from a uniform distribution between [−η, η]. The resulting input was remapped to be positive, and normalized. As can be seen in FIGS. 4A-B, the performance of the system is robust with respect to noise. Furthermore, the classification accuracy deteriorates less rapidly than the deconvolution accuracy.

Entrainment Analysis.

The conditions for entrainment of limit cycle oscillators have been studied at length, beginning with the pioneering work of Winfree and Kuramoto. A. Winfree, “The geometry of biological time,” New York: Springer-Verlag (1980); Y. Kuramoto, “Chemical oscillations, waves, and turbulence,” Berlin: Springer-Verlag (1984). However, the class of oscillators that we discuss here have been less studied. In particular, Kuramoto demonstrated that the interaction between limit cycle oscillators with comparable natural frequency can be expressed as a sinusoidal function of their phase difference. Although a thorough investigation of the dynamical properties of the system introduced herein is beyond the scope discussed herein, we present here a simplified analysis of entrainment conditions, which shows qualitatively similar properties as those described in the case of pure relaxation oscillators. Specifically, we will use pure sinusoidal functions for the phase interaction terms, as opposed the ones used in our simulations.

In the case of a full (upper layer) oscillator coupled to a reduced (lower layer) oscillator, or more generally an oscillator that receives only phase feedback. In this case, the update equations are:
\dot{τ}₂=−τ₂+τ₁W₂₁ cos φ (5)
\dot{θ}₂=ω₂+τ₁W₂₁ sin θ (6)
\dot{θ}₁=ω₁−τ₂W₁₂ sin θ (7)
where φ=θ₂−θ₁. From the equilibrium conditions \dot{τ}₂=0 and φ=0, the following equation can be derived for the phase difference under entrainment: τ₁W₂₁ sin φ(1+τ₁W₁₂ cos φ)=Δω, where Δω=ω₁−ω₂, This implies that if Δω>τ₁W₂₁(1+w₁₂τ₁) entrainment is possible. The condition for entrainment at small difference leads to: φ˜Δω/(τ₁W₂₁(1+W₁₂τ₁)), which makes evident that a driving or lower layer unit with high amplitude can synchronize with a small phase difference with the upper layer, and that this can also be achieved by a strong feedback connection.

Now let's consider the case of two upper layer units that interact through mutual inhibition, receiving independent inputs. Simplifying, we assume that the lateral connections are identical and not too strong, so that the units do not shut each other down. In this case, we can write the equations as:
\dot{τ}₁=−τ₁+A−τ₂ cos φ (8)
\dot{θ}₁=ω₁−τ₂ sin φ (9)
\dot{τ}₂=−τ₂+B=τ₁ sin φ (10)
\dot{θ}₂=ω₂+τ₁ sin φ (11)

A similar analysis for the entrainment (or rather exclusion in this case) condition leads to: (A+B)(1−cos φ)=Δω sin φ. Clearly, φ=0 is a solution, but an unstable one. If (A+B)≅Δω, the solution is near π/2, more precisely φ≅π/2+Δω/(A+B)−1.

Finally, we can analyze the behavior of this simple system when lateral connections are strong, which will be the case after learning. We write the amplitude update as:
\dot{τ}₁=−τ₁+A−W₁₂τ₂ cos φ
\dot{τ}₂=−τ₂+B−W₂₁τ₁ cos φ

For large connections strengths, one of the amplitudes will eventually reach zero, and therefore the steady state solution will say r₁=A, r₂=0. In this case, the entrainment condition is ω₁=ω₂−ω₁₂ A sin φ, and therefore the entrainment condition is satisfied by:
sin φ=Δω/(AW₁₂).

Therefore, while there has been described what is presently considered to be the preferred embodiment, it will be understood by those skilled in the art that other modifications can be made within the spirit of the invention.

We claim:

1. A computer-implemented method for performing segmentation of an input vector signal received at an input level and providing an output at an output layer, comprising steps of:
receiving at the input layer, a signal comprising a first component and a second component, wherein the input layer and the output layer each comprise a plurality of oscillator units, each comprising an amplitude and a phase;
learning the connection weights between the oscillator units based on a sample of representative inputs;
updating the phase and amplitude of each oscillator unit; and
segmenting the signal into classes at the input layer, based on active units in the output layer, such that units in each class have similar phases at the input and output layers.

2. The method of claim 1, wherein the step of learning comprises using a Hebbian rule.

3. The method of claim 1, wherein the step of segmenting further comprises segmenting into classes at the input and intermediate layers.

4. The method of claim 1, wherein different classes of oscillatory units comprise an oscillatory frequency.

5. The method of claim 1 wherein each unit is connected to other units.

6. The method of claim 5 wherein the connections fall into categories of feedforward, feedback, and lateral.

7. The method of claim 6 wherein each category affects the receiving node in different ways.

8. The method of claim 1 wherein the learning step is unsupervised and based on a Hebbian update.

9. The method of claim 5 wherein the input comprises xₙ ε [0,1]^{N}, |xₙ|=1∀n, where xₙ is the nth vector.

10. The method of claim 1 further comprising learning the connection weights based on the amplitude and phase of the oscillators.

11. The method of claim 1 further comprising the step of identifying the presence of the first component at the input layer.

12. The method of claim 1 further comprising the step of identifying the presence of a mixture of the first and second elements at the input.

13. The method of claim 1 further comprising the step of segmenting the first and second components.

14. The method of claim 13 wherein elements of the first and second components at the input layer are in phase with the corresponding elements at the output layer.

15. A network comprising:
a input layer of oscillator nodes for receiving an input from an input signal and comprising dynamical units;
an output layer of oscillator nodes, wherein the output layer is for receiving an input from the input layer through feedforward connections; wherein the amplitude and the phase of the top oscillator units are computed by integrating inputs as a function of the amplitude of the output oscillator units and the phase difference of the top dynamical units with respect to the receiving phase;
wherein the amplitude output of the input dynamical units is a function of the inputs and wherein the phase of the input dynamical units is a function of the internal frequency of the input dynamical units and feedback with the output layer; and
wherein the output layer sends feedback to the input layer, the feedback being used to modify only the phase of the input layer's units as a function of the incoming amplitudes and phase differences with respect to the receiving phases.

16. The network of claim 15 wherein the output layer identifies a presence of a component at the input layer.

17. The network of claim 15 wherein the output layer identifies a presence of a mixture of components at the input layer.

18. The network of claim 15 wherein the output layer segments components of first and second components at the output layer.

19. A computer readable medium comprising program code for:
receiving at an input layer, a signal comprising a first component and a second component, wherein the input layer and the output layer each comprise a plurality of oscillator units, each comprising an amplitude and a phase;
learning the connection weights between the oscillator units based on a sample of representative inputs;
updating the phase and amplitude of each oscillator node; and
segmenting the signal into classes at the input layer, based on active units in the output layer, such that units in each class have similar phases at the input and output layers.

20. The medium of claim 19 further comprising program code for learning the connection weights based on the amplitude and phase of the oscillators.

21. The medium of claim 19 further comprising program code for segmenting the first and second components.

22. The medium of claim 19 further comprising program code for identifying the presence of the first component at the input layer.

23. The medium of claim 19 further comprising program code for identifying the presence of a mixture of the first and second elements at the input.
